(19) United States
(12) Patent Application Publication
(10) Pub. No.: US 2008/0272149 A1
(43) Pub. Date: Nov. 6, 2008

(54) Dual component dispenser

(76) Inventor: R. Craig Virnelson, Chesterland, OH (US)

Correspondence Address: RALPH E. JOCKE;walker & jocke LPA, 231 SOUTH BROADWAY, MEDINA, OH, 44256, US

(21) Appl. No.: 12/074,862

(22) Filed: Mar. 5, 2008

Related U.S. Application Data
(60) Provisional application No. 60/904,867, filed on Mar. 5, 2007.

(51) Int. Cl. B67D 5/52

(52) U.S. Cl. 222/137; 222/135

(57) ABSTRACT

A dual component dispenser for simultaneous delivery of two fluid products at a preset ratio, includes a cylindrical container having in series a front (28) and a back chamber (30) in axial alignment, each of said chambers (28, 30) having an interior volume being defined by a fixed front wall (11, 24), side walls (12, 14), and a plunger (20, 22). The plungers (20, 22) are formed such that they are slidably movable inside the side walls (12, 14) of their respective chambers, wherein movement of the back plunger (22) effects synchronous movement of the front plunger (20). The dispenser further includes a nozzle (10) attached to the front wall (11) of the front chamber (28) and a conduit (26) within the container for conveying the content of the back chamber (30) directly to the nozzle (10). The conduit (26) is a cylindrical telescopic tube consisting of a front inner tube (16) and a back inner tube (18). The dispenser further includes a flow connection (46) to allow discharge of the content of the back chamber (30) into the back inner tube (18). The front inner tube (16) extends between the fixed front walls (11, 24) of the front and back chambers (28, 30). The back inner tube (18) is rigidly fixed between the plungers (20, 22), whereby the fixed front wall (24) of the back chamber (30) has an aperture (25) to slidably engage the back inner tube (18), and the front plunger (20) has an aperture (21) constructed to slidably engage the front inner tube (16) for movement thereon.

### CROSS REFERENCE TO RELATED APPLICATION

This application claims benefit pursuant to 35 U.S.C. § 119(e) of Provisional Application 60/904,867 filed Mar. 5, 2007.

### TECHNICAL FIELD

The present invention relates to a dual component dispenser.

### BACKGROUND ART

There are many types of dispensers that are available for dispensing a plurality of components. These fluid components include chemically reactive resins, resins and hardener, various sealants, caulks, and even toothpaste, etc. This is currently accomplished by a variety of means including concentric tubes and side-by-side tubes, both requiring a special dispensing “gun.” What is sometimes desirable is a system which requires only the same gun as for a single component tube.

U.S. Pat. No. 5,954,236 describes a segmented tube in which only the connected plungers move to discharge the fluid products. U.S. Pat. No. 5,310,091 describes a tube within a tube where the sidewall of the moveable back tube pushes the front plunger. U.S. Pat. No. 4,220,261 is nearly identical in mechanical action except the two tubes telescope as the fluid product is discharged.

U.S. Pat. No. 4,220,261 has not been commercially used because telescoping action presented storage issues. One design (U.S. Pat. No. 5,310,091) has attained commercial use but suffers from high friction and low volume as well as the inability to deliver different ratios of the fluid products. Another such solution (U.S. Pat. No. 5,954,236) has overcome those restrictions, but has not been accepted in the market because of potential difficulties in creating tight seals and the distribution of internal hydrostatic forces. Each of the aforementioned solutions suffers from difficulties in molding the dispenser parts which also makes them expensive to manufacture. Various others have attempted to use flexible internal dispenser parts, but discharge ratios are not consistent.

Dispensers may benefit from improvements.

### OBJECTS OF EXEMPLARY EMBODIMENTS

It is an object of an exemplary arrangement to provide a dual component dispenser that allows a first fluid product contained in the first chamber to be maintained separate from a second fluid contained within a second chamber and dispensed simultaneously together with a single discharge nozzle.

It is another object of an exemplary arrangement to provide a dual product dispenser that discharges two products in a preset ratio through the nozzle.

It is another object of an exemplary arrangement to provide a dual product dispenser that allows one force to be applied at the rearward chamber to synchronously dispense both products from their respective chambers by use of a standard dispensing gun as used e.g. for single component dispensers.

It is another object of an exemplary arrangement to provide a dual product dispenser that allows filling the void between the tube separator and the front plunger when discharging the fluid products.

Aforementioned objectives are solved in an exemplary arrangement by a dual component dispenser that may be filled with two separate fluid components or products and allows them to be discharged synchronously in a preset ratio and be mixed within a nozzle of the dispenser while discharging them.

A dual component dispenser according to the exemplary arrangement is for simultaneous delivery of two fluid products at a preset ratio. The dispenser comprises a cylindrical container having in series a front and a back chamber in axial alignment. Each of said chambers has an interior volume being defined by a fixed front wall, side walls and a movable rear wall. The fixed front wall of the front chamber may be constructed in one piece with the nozzle. The side walls preferably are formed by cylindrical tubes, in particular by two tubes in series, so called front and back tubes. The movable rear walls preferably are plungers and are formed such that they are slidably movable inside the side walls or tubes of their respective chambers. The movement of the rear wall of the back chamber effects synchronous movement of the rear wall of the front chamber.

A nozzle of the exemplary arrangement is attached to the front wall of the front chamber. The nozzle surrounds at least one port in the front wall of the front chamber. The exemplary dispenser further comprises a conduit within the container for conveying the contents of the back chamber directly to the nozzle. The conduit is preferably a cylindrical telescopic tube consisting of a front inner tube and a back inner tube. The dispenser also comprises a flow connection to allow discharge of the content of the back chamber into the back inner tube. The front inner tube fluidly extends between the fixed front walls of the front and back chambers. The fixed front wall of the back chamber is also designated as a dividing wall or tube separator. The tube separator advantageously is placed or formed at about one-half the length of the container. The back inner tube is in rigidly fixed engagement with the movable rear wall or plunger. The tube separator has an aperture, the so called separator hole, to slidably engage the back inner tube therein. The front plunger also has an aperture, the so called front plunger hole, constructed to slidably engage the front inner tube therein for movement thereon.

In an exemplary embodiment the nozzle surrounds two ports, one for discharging the content of the front chamber and one for discharging the content of the back chamber. Alternatively the nozzle may also surround only one port, where the conduit ends in this port and where the cross-sectional area of the port is larger than that of the conduit thus allowing the content of the front chamber to be discharged through the opening between the conduit and the inner surface of the one port.

In an exemplary embodiment the flow connection consists of at least one aperture in the backside of the back inner tube. This aperture may have any cross-sectional shape, in particular may be an opening or hole having a circular or polygonal cross-section, or may be a slit. In particular, the flow connection may consist of an aperture in the cylindrical shell of the back inner tube. The flow connection may also comprise connection channels within the movable rear wall of the back chamber which are formed such that the content of the back chamber can be discharged through the connection channels to the back inside of the back inner tube. In another alternative embodiment the flow connection may comprise flow channels in the back plunger and additionally also at least one aperture in the cylindrical shell of the back inner tube.

In an exemplary embodiment, the front and back inner tubes are placed coaxially, and the inner tubes are formed such that the back inner tube is slidably and sealingly movable over the front inner tube.

The front inner tube is positioned in axial alignment with the nozzle. In particular, the front inner tube may extend through the at least one port in the front wall of the front chamber.

In the exemplary embodiment, at least some of the dispenser parts movable relative to each other are provided with sealing means between their corresponding adjacent sliding surfaces.

In an exemplary arrangement, the front inner tube forms a stationary part of the conduit and is rigidly operatively coupled to the nozzle, or is formed in one piece with the nozzle. The forming in one piece may be effected by molding the structure from suitable plastic or other material.

In a further exemplary embodiment, a side wall of the container includes an aperture, a so called breather hole. The breather hole is located between the movable rear wall of the front chamber and the dividing wall which is the front wall of the second chamber for allowing air to flow therebetween upon filling or discharging the fluid components. The exemplary breather hole allows air to flow into or from the void created between the front plunger and the tube separator during filling or discharging the content of the chambers.

The exemplary container is in the form of a circular hollow cylinder where the cylinder shell forms the side walls of the front and back chambers. The front and back chambers may have an approximately equal cross-sectional area. In another exemplary embodiment, the front and back chambers may have different cross-sectional areas to allow a specific ratio of the contents of the front and back chambers to be discharged.

In an exemplary embodiment, the nozzle is located in axial alignment with the central axis of the container. The nozzle may be a static mixer nozzle. The nozzle may also comprise a needle, in particular for medical applications.

In an exemplary arrangement, the front and back inner tubes each have a circular cross-section but in other embodiments other approaches may be used.

The front wall of the back chamber, i.e. the tube separator, may be rigidly attached to the side walls at about one-half the length of the container. In another exemplary embodiment, the tube separator may also be formed in one piece with the side walls, in particular with the side walls of the back chamber.

In an exemplary arrangement the front and rear walls, the side walls, the nozzle and the front and back inner tubes may be formed from a material selected from the group including glass, plastic, fluoroplastic material, polymer, metal, and metallic alloys or combinations thereof.

In an exemplary embodiment the back inner tube and the rear wall of the back chamber are formed in one piece, e.g. by a molding technique.

In a still another exemplary embodiment the back inner tube and the rear wall of the front chamber are formed in one piece, e.g. by molding technique.

In accordance with an exemplary arrangement, there is provided a dual component dispenser that is simple in design and economical to manufacture. The container of the exemplary dispenser would consist of a segmented tube with two separate chambers containing the two components. A conduit would allow fluid communication between the second chamber and a nozzle that also receives fluid from the first chamber. One part of the conduit, namely the back inner tube, also serves as the connecting member of the plungers which transfers forward movement from the back plunger to the front plunger and which allows synchronous discharge of the two components. Additionally, the ratio of the components may be varied by changing the ratio of the diameters of the first and second chambers.

### BRIEF DESCRIPTION OF DRAWINGS

FIG. 1 is an exploded view of an exemplary dual product dispenser.

FIG. 2 is a longitudinal section view through an exemplary dual product dispenser in a full position.

FIG. 3 is a longitudinal section view through an exemplary dual product dispenser in a partially dispensed position.

FIG. 4 is a longitudinal section view through an exemplary dual product dispenser in an empty position.

FIG. 5 shows a partially exploded view of an exemplary embodiment.

FIG. 6 shows an alternative tube front section having a different cross sectional area to provide simultaneous dispensing of different amounts of each of two materials.

FIG. 7 is an exploded view showing exemplary molded components produced through a method of manufacture of an exemplary embodiment.

### DETAILED DESCRIPTION OF EXEMPLARY EMBODIMENTS

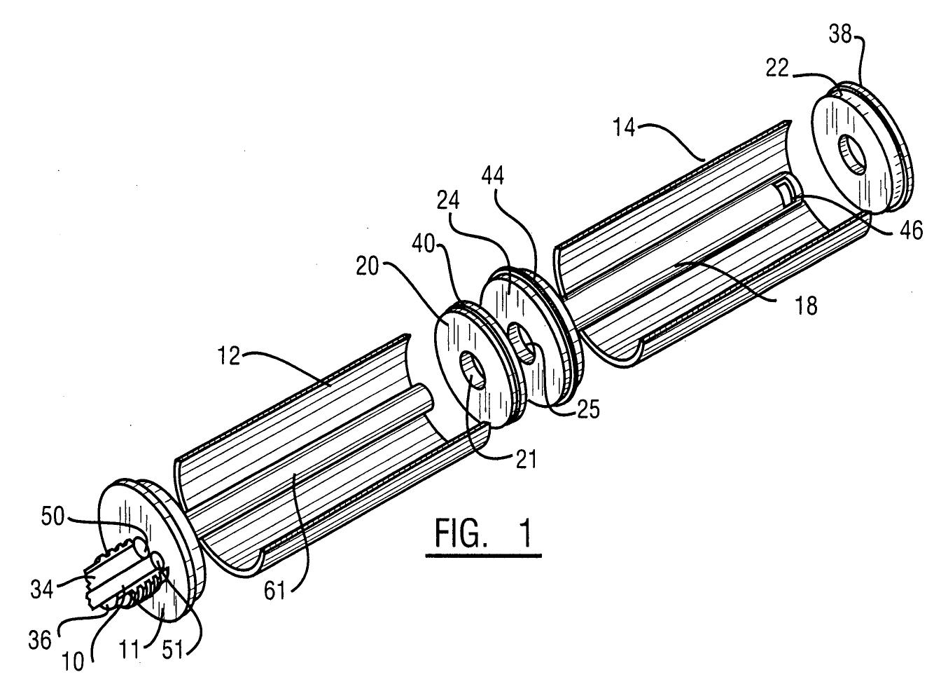

FIG. 1 shows an exemplary dual product dispenser comprising two tubes 12, 14, where only one half shell of each tube is shown.

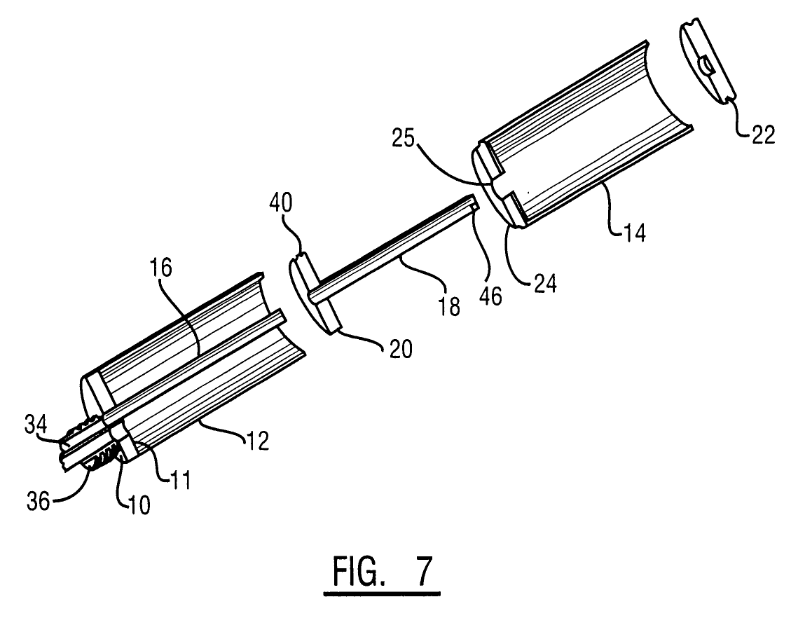

The exemplary dual product dispenser preferably comprises four molded parts (see also FIG. 7). The first part comprises a nozzle 10 having a back product port 34 and a front product port 36, a fixed front wall 11, a front tube 12 and a front inner tube 16. The fixed front wall 11 includes two through holes 50, 51 where through hole 50 encompasses the front inner tube 16. Alternatively the front inner tube 16 may be sealingly attached to the inner circumference of the through hole 50, or the fixed front wall 11 and the front inner tube 16 may be formed in one piece having a through hole 50 connecting the inner area of the front inner tube 16 with the back product port 34 of the nozzle 10.

The second part comprises a back outer tube 14 and a fixed front wall of the second chamber, called tube separator 24. The exemplary separator 24 includes a through hole, the so called separator hole 25, and includes an inner separator seal element 42 for sealing the outside of the movable back inner tube and the hole in the tube separator 24. In an exemplary embodiment the seal may include a resilient annular projection. Of course in other embodiments other integral or separate seal structures to minimize material leakage around the outside of the tube and through the separator hole may be used. The exemplary tube separator further includes an outer tube separator seal element 44 for sealing with the two chambers, in particular for separating the contents of the back and front chambers 28, 30 during filling, storage and discharge of the components. As indicated in FIG. 7 in some embodiments the tube separator may be formed in integrally molded relation with tube 14.

The third part of the exemplary embodiment is a plunger assembly including of a front plunger 20 and a back inner tube 18. The back inner tube 18 has at first back side end an aperture 46. In the exemplary embodiment the aperture extends through a side wall of tube 18. The front plunger 20 has a circumferential front plunger seal 40. Seal 40 may include an annular resilient structure or other suitable integral or separate seal structure for minimizing material flow between plunger 20 and the inner wall of tube 12.

The fourth part of the exemplary embodiment is a back plunger 22 comprising a back plunger seal 38. The plunger seal 38 may be of the types previously described. The back plunger 22 further has a countersunk area for engagement of the back inner tube 18. Such engagement provides for aperture 46 to be in fluid communication with the second chamber.

In alternative embodiments the plunger assembly may consist of a back plunger 22 and a back inner tube 18 molded in one piece, where the front plunger 20 is formed as a separate element.

The front chamber 28 includes a nozzle 10, a fixed front wall 11, a front tube 12 and a front inner tube 16, and contains one of the two components or products to be dispensed at a discharge point 34, 36 for both products.

The back chamber 30 includes and is bounded by the tube separator 24 and the back tube 14, and contains the second of the two components or products to be dispensed.

The exemplary plunger assembly consists of a front plunger 20 and a back plunger 22 rigidly operatively connected by the back inner tube 18. The back inner tube 18 provides for synchronous movement of the plungers and provides an even distribution of the applied forces.

The exemplary assembly of the nozzle 10 with the fixed front wall 11 forms the fixed end of the front chamber 28. The dispensed components or products from the front and back chambers are combined in the nozzle 10 as they exit.

The front tube 12 forms the outer wall of the front chamber 28, and the back tube 14 forms the outer wall of the back chamber 30. The front tube 12 is connected to the fixed front wall 11 of the front chamber 28, or in some embodiments the front tube 12 and the fixed front wall 11 are formed as one integral piece.

The back tube 14 is connected to the tube separator 24, i.e. the fixed front wall of the second chamber. The diameter of the front tube 12 may be different from that of the back tube 14 in order to vary the volume ratio of the two products to be dispensed. Alternatively the front tube may include an inner tube to vary the effective diameter from that of the back tube. This may be done using a structure for the front tube portion like that shown in FIG. 7. Of course this approach is exemplary.

The exemplary conduit 26 for conveying the contents of the back chamber 30 through the back end aperture 46 of the back inner tube 18 to the nozzle 10 includes the telescoping front and back inner tubes 16, 18. The front inner tube 16 forms the stationary half of the conduit 26. The back inner tube 18 forms the movable half of the conduit 26 for conveying the content of the back chamber 30 to the nozzle 10.

The exemplary front plunger 20 for pushing the content of the front chamber 28 through the nozzle 10 is rigidly operatively connected to the back inner tube 18. The front plunger 20 comprises a front plunger seal 40 for sealing with the front tube 12. The front plunger 20 comprises a front plunger hole 21 constructed to slidably engage the front inner tube 16 for movement thereon.

The back plunger 22 is moved forward toward the nozzle and is operative to push the contents of the back chamber 30 through the aperture 46, through the inner tubes 16, 18 and to the nozzle 10. The back plunger 22 comprises a back plunger seal 38 for sealing with the inner wall back tube 14. Seal structures of the type previously described may be used in exemplary embodiments.

The exemplary front tube 12 comprises a breather hole 32 located longitudinally between the tube separator 24 and the front plunger 20. The breather hole is preferably located close to the separator 24 and allows air to escape or to enter the void formed between the front plunger 20 and the tube separator 24 during dispensing or filling the chambers 28, 30 of the dispenser.

The exemplary nozzle 10 is attached to the fixed front wall 11 of the front chamber 28 or alternatively is formed in one piece with this front wall 11. The nozzle 10 surrounds two ports 50, 51 in the front wall 11 of the front chamber 28. Port 50 operates to discharge the content of the back chamber 30, and port 51 operates to discharge the content of the front chamber 28. The exemplary nozzle 10 comprises a back product port 34 fluidly connected to port 50 for discharging the content of the back chamber 30. The exemplary nozzle 10 also comprises a front product port 36 fluidly connected to port 51 for discharging the content of the front chamber 28.

The exemplary back plunger 22 comprises a back plunger seal 38 for preventing product leakage from the back chamber 30 out of the dispenser during filling, storage and discharge of the content of the back chamber 30.

The exemplary tube separator 24 includes the fixed front wall bounding the back chamber 30. The exemplary tube separator 24 comprises a tube separator seal 44 for preventing leakage of the content of the front and back chambers 28, 30 during filling, storage and discharge of the products. The tube separator 24 has a separator hole 25 to slidably engage the exterior of back inner tube 18. In order to seal this engagement, the tube separator also has a inner separator seal element 42. The seal element in hole 25 may be of the types previously described. Of course as previously discussed in some alternative embodiments, separator 24 may be integrally molded or otherwise formed with tube 18.

The seal elements, in particular the back plunger seal 38, the front plunger seal 40, the tube separator seal 44 and the inner separator seal element 42 may include ring-shaped elements attached to the peripheral surface of the corresponding elements. Alternatively some embodiments may include annular elements molded or otherwise integrally formed therewith.

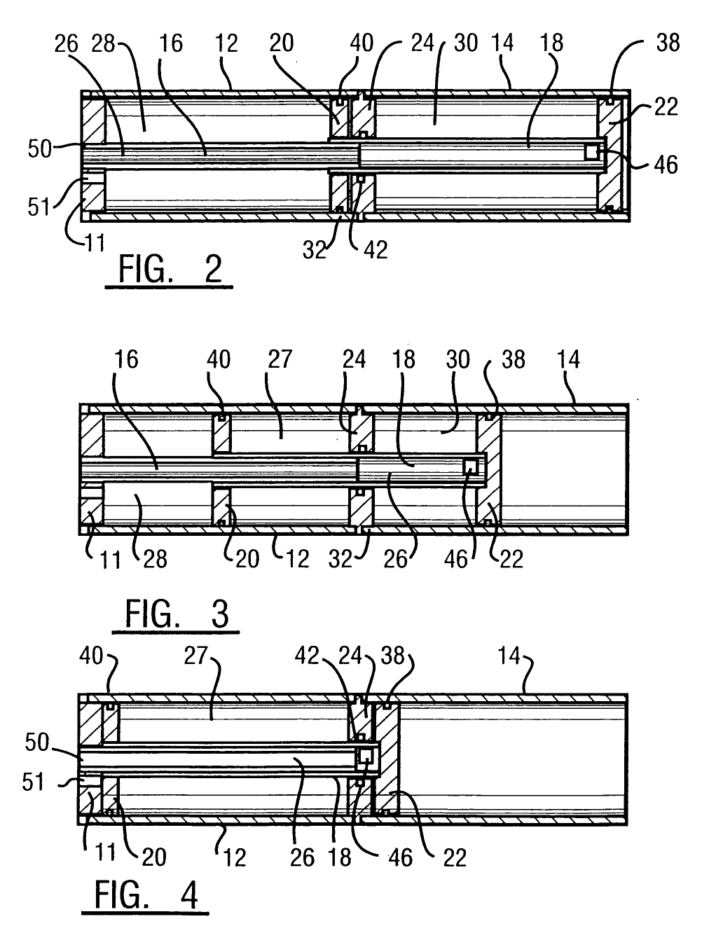

FIG. 2 shows a longitudinal section view through an exemplary dispenser in a full position. In this configuration, the back plunger 22 is located at the rear end of the back tube 14, and the front plunger 20 is located close to the tube separator 24. The front tube 12 has a breather hole 32 between front plunger 20 and tube separator 24. The front and back chambers 28, 30 shown have the same diameter and are attached to each other through the tube separator 24. The central axis of the front inner tube 16 and the back inner tube 18 coincide with the central axis of the container and are in axial alignment with port 50 engaging the front inner tube 16.

FIG. 3 shows a longitudinal section view through an exemplary dispenser in a partially dispensed position. During the movement of the plungers 20 and 22 from the position shown in FIG. 2 to the position shown in FIG. 3 a part of the content of the back chamber 30 has been discharged through the aperture 46 of the back inner tube 18 and the conduit 26, i.e. the telescopic inner tubes 16 and 18, to port 50 of the front wall 11 of the front chamber 28. Simultaneously, a part of the content of the front chamber 28 has been discharged through port 51 formed in the front wall 11 of front chamber 28. FIG. 3 also shows the void 27 formed between front plunger 20 and tube separator 24 which may be filled with air that may be supplied through breather hole 32.

FIG. 4 shows a longitudinal section view trough an exemplary dispenser in an empty condition. The back plunger 22 contacts or is in close proximity to tube separator 24, and front plunger 20 contacts or is in close proximity to front wall 11 of the front chamber 28. In this position, the front plunger 20 may close ports 50, 51 on the rear side of the front wall 11.

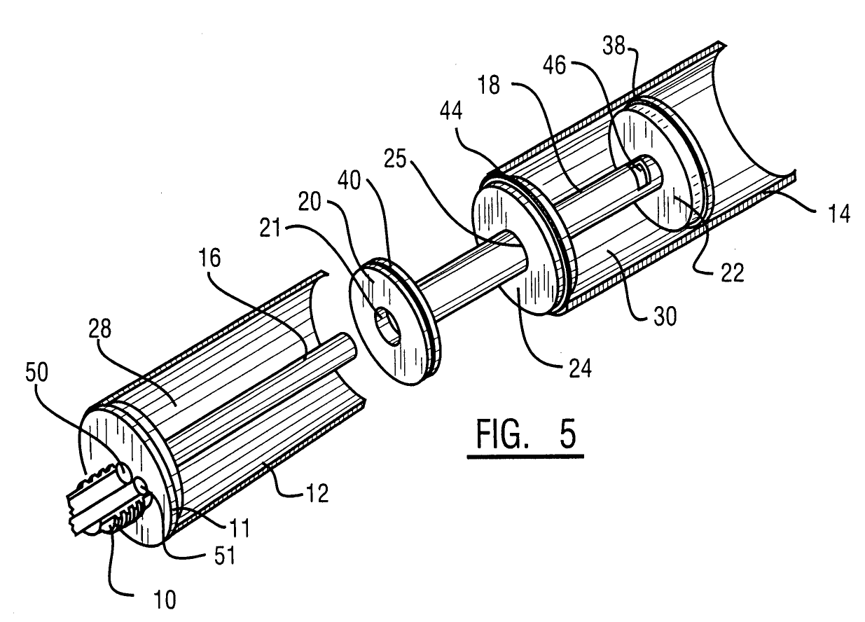

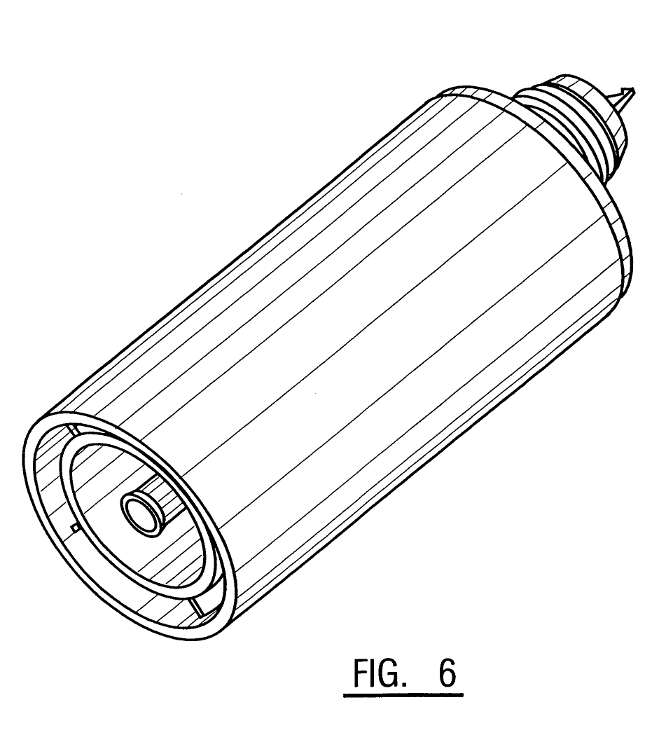

FIG. 5 shows a partially exploded view of an exemplary dual component dispenser embodiment. The front and back tubes 12, 14 are only shown as half shells. The dispenser shown in FIG. 5 consists of two parts. The first part contains a front tube 12, a front wall 11 of the front chamber 28, a nozzle 10 and a front inner tube 16 engaged within port 50. The front wall 11 further includes a second port 51 for discharging the content of front chamber 28. The second part consists of a back tube 14, a tube separator 24 having a separator hole 25 slidably engaging a back inner tube 18, and front and back plungers 20, 22 rigidly connected to the back inner tube 18. The exemplary back inner tube 18 includes an aperture 46 for discharging the content of back chamber 30 through back and front inner tubes 16, 18 to port 50. An assembled dispenser may be formed by bringing together the first and second parts, i.e. by affixing the front tube 12 to the tube separator 24 and by passing the front inner tube 16 through front plunger hole 21 into back inner tube 18.

It should be understood that other alternative embodiments may provide for dispensing of more than two fluid components. This may be accomplished, for example, by providing another longitudinally aligned tube section and plunger arrangement. Further in such exemplary alternative embodiments telescoping tube arrangements may be provided between the third compartment and the nozzle. This may be accomplished for example by providing a telescoping tube arrangement that includes a plurality of telescoping tube sections, that is separate from the structural arrangement that translates the movement of the rear plunger which bounds the end of the tube on the side opposed from the nozzle. Stated differently, in some embodiments a mechanical structure may serve to transmit dispensing force applied to the plunger bounding a third or other tube section, while a telescoping tube arrangement within the interior of the dispenser provides for transmission of the material through the various intermediate chambers to the nozzle. As may be appreciated this approach may facilitate producing dispensing structures with three or more component materials that are simultaneously dispensed therefrom. Of course it should be understood that these approaches are exemplary.

It should further be understood that in exemplary embodiments the dispenser may be configured in the manner of a conventional caulking tube. In this way both materials may be dispensed by placing the dispenser in a conventional caulking gun type mechanism. Of course in alternative embodiments alternative structures and mechanisms may be used to operate the dispenser.

As will be appreciated, exemplary embodiments of the dispenser will be comprised of materials compatible with the materials to be housed therein and dispensed. In some embodiments all components of the dispenser structures may be of a single suitable material. In alternative embodiments different components of the dispenser may be comprised of different materials that are best suited toward the particular material to be housed in the corresponding portion of the dispenser.

A method of manufacture of an exemplary embodiment may include as previously discussed, molding the tube 12, nozzle 10 and inner tube 16 as a unitary structure of a suitable plastic material. The tube 14 and dividing wall 24 may likewise be made as a molded unitary structure. The plunger 20 and tube 18 may also be molded or otherwise formed as a unitary structure, while the plunger 22 may be likewise molded or otherwise formed as a separate piece.

In an exemplary embodiment the dispenser is assembled by placing the plunger 20 within the interior of tube 12 and extending tube 18 in telescoping overlying relation of tube 16. Tube 18 is extended through opening 25 and plunger 22 is attached to the end of tube 18 that extends at an opposed end of plunger 20. Tube 12 is attached to tube 14 through fixed engagement with dividing wall 24. This may be done through suitable heat sealing, ultrasonic sealing, adhesive material or other suitable attaching method. Of course this approach is exemplary.

Further as previously discussed, in alternative embodiments tube 18 and plunger 22 may be formed as an integral structure. Plunger 20 may then be attached to tube 18 at an end opposed of plunger 22 after tube 18 has been extended through opening 25. Of course these methods of making the dispenser are exemplary and in other embodiments other approaches may be used.

Further as represented in FIG. 6, the front portion of the dispenser assembly may be formed to have a different internal diameter than the rear tube. As can be appreciated, this different internal diameter provides for dispensing a lesser amount of material from the front compartment of the dispenser for a given amount of longitudinal plunger movement, compared to the amount of material dispensed from the rear compartment. As can be appreciated the ratio of the materials dispensed will be the ratio of the cross sectional areas of the compartments.

In various embodiments the dispenser may be used for dispensing materials that must be dispensed simultaneously and/or mixed together at the point of dispensing. This may include for example adhesives, sealants, fillers or similar materials. This may further include other types of reactive chemical compounds. Alternatively such materials may include therapeutic materials such as medicines that must be provided to patients simultaneously and in controlled doses. Of course these uses and materials are merely exemplary and in other embodiments other approaches may be used.

Thus the features and characteristics of the exemplary embodiments previously described achieve desirable results, eliminate difficulties encountered in the use of prior devices, solve problems and attain one or more of the objectives stated above.

In the foregoing description certain terms have been used for brevity, clarity and understanding, however no unnecessary limitations are to be implied therefrom because such terms are for descriptive purposes and are intended to be broadly construed. Moreover, the descriptions and illustrations herein are by way of examples and the invention is not limited to the details shown and described.

In the following claims any feature recited as a means for performing a function shall be construed as encompassing any means known to those skilled in the art to be capable of performing the recited function, and shall not be limited to the particular means shown herein or mere equivalents thereof.

Having described the features, discoveries and principles of the invention, the manner in which it is constructed and operated, and the advantages and useful results attained; the new and useful structures, devices, elements, arrangements, parts, combinations, systems, equipment, operations, methods, processes and relationships are set forth in the appended claims.

1. A dual component dispenser for simultaneous delivery of two fluid components at a preset ratio, comprising:
a cylindrical container having in series a front (28) and a back chamber (30) in axial alignment, each of said chambers (28, 30) having an interior volume being defined by a fixed front wall (11, 24), side walls (12, 14), and a movable rear wall (20, 22); the rear walls or plungers (20, 22) are formed such that they are slidably movable inside the side walls or tubes (12, 14) of their respective chambers, wherein movement of the rear wall (22) of the back chamber (30) effects synchronous movement of the rear wall (20) of the front chamber (28),
a nozzle (10) attached to the front wall (11) of the front chamber (28), the nozzle (10) surrounding at least one port (50, 51) in the front wall (11) of the front chamber (28), and
a conduit (26) within the container for conveying the content of the back chamber (30) directly to the nozzle (10),
and wherein:
the conduit (26) includes a cylindrical telescopic tube consisting of a front inner tube (16) and a back inner tube (18),
the dispenser further includes a flow connection (46) to allow discharge of the content of the back chamber (30) into the back inner tube (18),
the front inner tube (16) extends between the fixed front walls (11, 24) of the front and back chambers (28, 30); the back inner tube (18) is rigidly fixed between the movable rear walls (20, 22) of the front and back chambers (28, 30), whereby the fixed front wall of the back chamber (24) has an aperture (25) to slidably engage the back inner tube (18), and
the rear wall (20) of the front chamber (28) including an aperture (21) constructed to slidably engage the front inner tube (16) for movement thereon.

2. A dual component dispenser according to claim 1, wherein the flow connection (46) comprises an opening in the back side of the back inner tube (18).

3. A dual component dispenser according to claim 1, wherein the flow connection (46) comprises an aperture in the cylindrical shell of the back inner tube (18).

4. A dual component dispenser according to claim 1, wherein the flow connection (46) comprises connection channels within the movable rear wall (22) of the back chamber (30) which are formed such that the content of the back chamber (30) can be discharged through the connection channels to the back inside of the back inner tube (18).

5. A dual component dispenser according to claim 1, wherein the front and back inner tubes (16, 18) are placed coaxially, and the inner tubes (16, 18) are formed such that the back inner tube (18) is slidably movable over the front inner tube (16).

6. A dual component dispenser according to claim 1, wherein the front inner tube (16) being positioned in axial alignment with the nozzle (10), and the front inner tube (16) passing through the port (50) in the front wall (11) of the front chamber (28).

7. A dual component dispenser according to claim 1, wherein the cross-sectional area of the port (50) in the front wall (11) of the front chamber (28) being larger than the cross-sectional area of the front inner tube (16) for allowing discharge of the content of the front chamber (28) through the port (50) into the nozzle (10).

8. A dual component dispenser according to claim 1, wherein at least some of the dispenser parts (20, 16, 18, 24, 22, 18) movable to each other are provided with sealing means (38, 40) between their corresponding sliding surfaces.

9. A dual component dispenser according to claim 1, wherein the front inner tube (16) forms a stationary part of the conduit (26) that is rigidly coupled to the nozzle (10), or is formed in one piece with the nozzle (10).

10. A dual component dispenser according to claim 1, wherein the side walls (12, 14) of the container include an aperture (32) located between the rear wall (20) of the front chamber (28) and the front wall (24) of the second chamber (30) for allowing air to flow therebetween upon filling or discharging the components.

11. A dual component dispenser according to claim 1, wherein the container is in the form of a circular hollow cylinder and the cylinder shell forms the side walls (12, 14) of the front and back chambers (28, 30).

12. A dual component dispenser according to claim 1, wherein the front and back chambers (28, 30) have an approximately equal cross-sectional area.

13. A dual component dispenser according to claim 1, wherein the front and back chambers (28, 30) have different cross-sectional areas.

14. A dual component dispenser according to claim 1, wherein the nozzle (10) is located in axial alignment with the central axis of the container.

15. A dual component dispenser according to claim 1, wherein the front and back inner tubes (16, 18) each having a circular cross-section.

16. A dual component dispenser according to claim 1, wherein the nozzle (10) is a static mixer nozzle.

17. A dual component dispenser according to claim 1, wherein the front wall (24) of the back chamber (30) is rigidly attached to the side walls (14) at half-length of the container.

18. A dual component dispenser according to claim 1, wherein the front wall (24) of the back chamber (30) is formed in one piece with the side walls (14) of the back chamber (30).

19. A dual component dispenser according to claim 1, wherein the container, the front and rear walls (11, 20, 24, 22), the side walls (12, 14), the nozzle (10) and the front and back inner tubes (16, 18) are formed from a material selected from the group consisting of glass, plastic, fluoroplastic material, polymer, metal, and metallic alloys.

20. A dual component dispenser according to claim 1, wherein the back inner tube (18) and the rear wall (22) of the back chamber (30) are formed in one piece.

21. A dual component dispenser according to claim 1, wherein the back inner tube (18) and the rear wall (20) of the front chamber (28) are formed in one piece.

22. A dual component dispenser apparatus comprising:
a first tube segment and a second tube segment, wherein the first tube segment and the second tube segment are in axial alignment;
wherein the first tube segment defines a first chamber adapted for holding a first fluid material, and wherein the second tube segment defines a second chamber adapted for holding a second fluid material;
a dividing wall generally fluidly separating the first chamber and the second chamber;
an end cap portion, wherein the end cap portion bounds the first chamber on an axial end opposed of the dividing wall;
wherein the end cap portion includes a first fluid opening and a second fluid opening;
a first rigid conduit extending in an axial direction in the first chamber, wherein the first fluid conduit includes a first fluid passage, wherein the first fluid passage is fluidly isolated from the first chamber, and wherein the first fluid passage is in communication with the first fluid opening in the end cap portion;
and wherein the second fluid opening is in fluid communication with the first fluid chamber;
a first plunger, wherein the first plunger is movably axially positioned in the first chamber, wherein the first plunger includes a first plunger opening, wherein the first plunger opening is sized to accept the first conduit therein in movable relation;
wherein the dividing wall includes dividing wall opening;
a second rigid fluid conduit, wherein the second fluid conduit extends in movably mounted relation in the dividing wall opening;
wherein the second conduit is in operative engagement with the first plunger;
wherein the second conduit is sized to accept the first conduit therein in telescoping relation;
wherein the second conduit includes a second fluid passage therein, wherein the second fluid passage is in fluid communication with the first fluid passage;
wherein the second conduit includes at least one fluid opening, wherein the fluid opening extends between the second internal passage and a second chamber;
a second plunger, wherein the second plunger is axially movable in the second chamber, and wherein the second plunger is operatively engageable with the second conduit;
wherein responsive to the second plunger being moved axially toward the end cap portion, the second plunger is operative to cause the first plunger to move, whereby a first material in the first chamber is dispensed through the second opening responsive to movement of the first plunger, and the second material in the second chamber is dispensed through the first opening by passing through the first and second fluid passages responsive to movement of the second plunger.

23. The apparatus according to claim 22 wherein the first chamber has a first cross sectional area and the second chamber has a second cross sectional area different from the first cross sectional area, wherein the first and second materials are dispensed at a ratio that corresponds to the respective cross sectional area.

24. The apparatus according to claim 23 wherein the end cap portion comprises a nozzle, wherein the nozzle is in fluid communication with both the first and second fluid openings.

25. The apparatus according to claim 24 wherein the at least one fluid opening in the second fluid conduit is disposed at an end of the second fluid conduit opposed of the first plunger.

26. The apparatus according to claim 25 and wherein the first tube segment includes a vent opening, wherein the vent opening is operative to enable air flow into an area between the first plunger and the dividing wall.

27. The apparatus according to claim 26 wherein the first conduit has a first outer annular surface and the second conduit includes a first inner annular surface, and wherein a first seal extends operatively between the first outer annular surface and the first inner annular surface.

28. The apparatus according to claim 22 wherein the dividing wall opening is bounded by a second inner annular surface, and wherein the second conduit is bounded by a second outer annular surface, and wherein a second seal extends operatively between the second inner annular surface and the second outer annular surface.

29. The apparatus according to claim 28 wherein the first chamber is bounded internally by a first inner chamber annular wall, and further comprising a first plunger seal, wherein the first plunger seal extends operatively between the first inner chamber annular wall and the first plunger.

30. The apparatus according to claim 29 wherein the second chamber is bounded internally by a second inner chamber annular wall, and further comprising a second plunger seal, wherein the second plunger seal extends operatively between the second inner chamber annular wall and the second plunger.

31. The apparatus according to claim 30 wherein the dividing wall includes a first circumferentially recessed lip, and wherein the first inner chamber annular wall engages the first circumferentially recessed lip.

32. The apparatus according to claim 30 wherein the dividing wall includes a circumferentially recessed lip, and wherein the second inner chamber annular wall engages the circumferentially recessed lip.
